(19) United States
(12) Patent Application Publication
(10) Pub. No.: US 2025/0253705 A1
(43) Pub. Date: Aug. 7, 2025

(54) UPLINK SCHEDULING OF COMPUTING DEVICES

(71) Applicant: QUALCOMM Incorporated, San Diego, CA (US)

(72) Inventors: Varun Amar REDDY, San Diego, CA (US); Sony AKKARAKARAN, Poway, CA (US)

(21) Appl. No.: 18/434,279

(22) Filed: Feb. 6, 2024

(51) Int. Cl. H02J 50/00; H04W 72/0446; H04W 72/0453; H04W 72/1268

(52) U.S. Cl. CPC H02J 50/001; H04W 72/0446; H04W 72/0453; H04W 72/1268

(57) ABSTRACT

Disclosed are systems and techniques for wireless communications. For example, computing device can receive an energizer transmission from an energizing device. The computing device can store energy from the energizer transmission. The computing device can transmit, based on the stored energy, a response signal using a particular frequency channel and/or a particular time based on a type of the computing device, the energizer transmission, and/or a configuration of a switch associated with the computing device.

### FIELD

The present disclosure generally relates to wireless communications. For example, aspects of the present disclosure relate to uplink scheduling of computing devices, such as ambient Internet of things (IoT) devices (e.g., transmit-only ambient IoT tags).

### BACKGROUND

Short range wireless communication enables wireless communication over relatively short distances (e.g., within thirty meters). For example, BLUETOOTH® is a wireless technology standard for exchanging data over short distances using short-wavelength ultra-high frequency (UHF) radio waves from 2.4 gigahertz (GHz) to 2.485 GHz.

BLUETOOTH® Low Energy (BLE) is a form of BLUETOOTH® communication that allows for communication with devices running on low power. Such devices may include beacons, which are wireless communication devices that may use low-energy communication technology for positioning, proximity marketing, or other purposes. In some cases, such devices may serve as nodes (e.g., relay nodes) of a wireless mesh network that communicates and/or relays information to a managing platform or hub associated with the wireless mesh network.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems and techniques for uplink scheduling of computing devices, such as transmit-only ambient IoT tags. According to at least one example, a method is provided for wireless communications. According to at least one example, a computing device for wireless communication is provided. The computing device includes at least one memory and at least one processor coupled to the at least one memory and configured to: receive an energizer transmission from an energizing device; store energy from the energizer transmission in the at least one memory; and output, based on the stored energy, a response signal for transmission using at least one of a particular frequency channel or a particular time based on at least one of a type of the computing device, the energizer transmission, or a configuration of a switch associated with the computing device.

In another illustrative example, a method is provided for wireless communication. The method includes: receiving, by a computing device, an energizer transmission from an energizing device; storing, by the computing device, energy from the energizer transmission; and transmitting, by the computing device based on the stored energy, a response signal using at least one of a particular frequency channel or a particular time based on at least one of a type of the computing device, the energizer transmission, or a configuration of a switch associated with the computing device.

In another illustrative example, a non-transitory computer-readable medium is provided having stored thereon instructions that, when executed by one or more processors, cause the one or more processors to: receive an energizer transmission from an energizing device; store energy from the energizer transmission; and output, based on the stored energy, a response signal for transmission using at least one of a particular frequency channel or a particular time based on at least one of a type of the computing device, the energizer transmission, or a configuration of a switch associated with the computing device.

In another illustrative example, an apparatus for wireless communication is provided. The apparatus includes: means for receiving, by a computing device, an energizer transmission from an energizing device; means for storing, by the computing device, energy from the energizer transmission; and means for transmitting, by the computing device based on the stored energy, a response signal using at least one of a particular frequency channel or a particular time based on at least one of a type of the computing device, the energizer transmission, or a configuration of a switch associated with the computing device.

Aspects generally include a method, apparatus, system, computer program product, non-transitory computer-readable medium, user equipment, base station, wireless communication device, and/or processing system as substantially described herein with reference to and as illustrated by the drawings and specification.

Some aspects include a device having at least one processor (one processor or multiple processors) configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a diagram illustrating an example environment in which systems and/or methods described herein may be implemented, in accordance with some aspects of the present disclosure.

FIG. 2 is a diagram illustrating example components of a device, in accordance with some aspects of the present disclosure.

FIG. 3 is a diagram illustrating an example of an enterprise resource planning (ERP) system infrastructure, in accordance with aspects of the present disclosure.

FIG. 4 is a signaling diagram illustrating example communication transmissions, in accordance with some aspects of the present disclosure.

FIG. 5 is a signaling diagram illustrating an example of communication transmissions between a network device and two groups of wireless communication devices, in accordance with some aspects of the present disclosure.

FIG. 6 is a diagram illustrating an example of ambient IoT devices configured with different configurations, in accordance with some aspects of the present disclosure.

FIG. 7 is a flow diagram illustrating an example of a process for uplink scheduling of transmit-only ambient IoT tags (e.g., in smart retail), in accordance with some aspects of the present disclosure.

FIG. 8 is a block diagram illustrating an example of a computing system, in accordance with some aspects of the present disclosure.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Short range wireless communication protocols enable wireless communication over relatively short distances (e.g., within thirty meters). For example, BLUETOOTH® is a wireless technology standard for exchanging data over short distances using short-wavelength ultra-high frequency (UHF) radio waves from 2.4 gigahertz (GHz) to 2.485 GHZ. BLUETOOTH® Low Energy (BLE) is a form of BLUETOOTH® communication that allows for communication with devices that operate using low power. Such devices may include beacons, which are wireless communication devices that can use low-energy communication technology for positioning, proximity marketing, or other purposes.

A system may include one or more wireless communication devices that are controlled by a network entity. For example, a system including multiple peripheral devices (e.g., an electronic shelf label (ESL) system) may include one or more wireless communication devices (e.g., peripheral devices, such as ESLs) that are controlled by a network entity, such as a management entity (ME) or edge server, via at least one network device, such as an access point (AP). As used herein, the terms “network entity” and “network device” may be interchangeable. For example, an AP can be referred to as an example of a “network entity” and/or can be referred to as an example of a “network device.” A “network entity” can include an AP, an ME, and/or a combination of the two. A “network device” can include an AP, an ME, and/or a combination of the two. In some examples, a single device can implement the functionality of an ME and an AP (e.g., an ME and an AP can be combined in a single device).

In one or more examples, to facilitate control by the ME (e.g., edge server), each peripheral device (e.g., ESL) may have a wireless connection (e.g., a BLE connection or other connection) to an AP that is communicatively connected to the ME (e.g., via the Internet, such as wirelessly, via an Ethernet connection, etc.). In some cases, commands from the ME may be wirelessly transmitted to the peripheral devices (e.g., ESLs) by the AP. Responses or information from the peripheral devices may also be received by the AP and provided by the AP to the ME.

In ESL systems, periodic Advertisements (PAs) can be utilized to provide regular and predictable payload transmissions from a central device (e.g., which may be in the form of a network device, such as an AP) to one or more peripheral devices (e.g., which may each be in the form of a wireless communication device, such as an ESL or other peripheral device). For example, PAs can be used to issue information from a central device to multiple peripheral devices, which may be within one or more groups of peripheral devices. PAs are generally unidirectional (e.g., unidirectional transmissions) such that PAs are transmitted only one-way from a central device to one or more peripheral devices.

Periodic Advertisement with Response (PAwR) can be used for ESL systems to provide bidirectionality (e.g., bidirectional transmissions between a central device and one or more peripheral devices). Peripheral devices synchronized within a group of peripheral devices can be addressed by a central device on a synchronized channel (e.g., a radio frequency (RF) channel between the central device and the peripheral devices) whenever the central device determines to send (e.g., transmit) a request to the peripheral devices. In some cases, as used herein, a synchronized channel refers to a channel on which transmissions are synchronized (in time). For example, the channel can utilize or can be based on a frequency on which one or more communications are transmitted. A hopping frequency sequence (HFS) can be associated with the channel. In some cases, the HFS may progress at a fixed and/or pre-determined interval. In some cases, a channel map may change, such as if interference on one or more channels changes, in which case the HFS can be updated (there may not be a fixed interval). In such cases, a minimum time between updates of a HFS can be applied, which can avoid updating the HFS too frequently. A central device and one or more peripheral devices can concurrently track the sequence at a predefined frequency hopping pattern or sequence (e.g., so the central device knows when to transmit the request and the peripheral devices know when to listen for and/or receive the request).

A request transmitted by a central device to peripheral devices in a particular group may be a PA containing a synchronization message transmitted by the central device on the synchronized channel to the peripheral devices of the particular group. For example, wireless communication devices within the particular group can wake up (e.g., from a low power (LP) mode) at the same PA transmission with respect to a particular PAwR train for that group. A PA is made up of a periodic set of transmissions, where the collection of transmissions is collectively referred to as a PA train or a PAwR train when applied to PAwR. Each transmission of a PA train (or PAwR train) occurs at a precise point in time, with fixed intervals between the transmissions. A communication channel (e.g., one communication channel out of thirty-seven available communication channels) is selected for each of the transmissions, where the communication channel follows a hopping frequency sequence. The synchronization between the central device and the peripheral devices in the group is based on the periodicity of the PA. The periodically-transmitted messages (e.g., the synchronization messages) include zero, one, or more commands (e.g., a respective operational code (OpCode) and parameters associated with each command). If a response from a peripheral device is expected by the central device (e.g., the synchronization message from the central device requests a response from a specific peripheral device), the particular peripheral device will respond in a specific response slot, based on where the peripheral device appeared within a sequence contained within the synchronization message transmitted by the central device.

Each access point may have an associated channel map. A channel map is a listing of frequency channels to be utilized or, conversely, not to be utilized (e.g., in the context of modification of frequency hopping sequences) by an access point for communication, such as with the ESLs or other devices. For example, for a particular PA train, PA packets can be transmitted on a particular number of channels (e.g., 37 data channels). The channels that are used and the channels that are not used can be indicated by the channel map. The channel map of an access point can be updated via a channel map update (CMU). A CMU is a procedure for updating (or changing) a current channel map (ChM) for an access point to a new channel map for the access point. As noted previously, the access point can send a synchronization message as a PA to the ESLs. The synchronization message can include various types of information, including information associated with a CMU in addition to other information. For example, when an access point is performing a CMU, information associated with the CMU can be included in one or more fields (e.g., an Additional Controller Advertising Data (ACAD) field) of a synchronization message. The CMU information included in a synchronization message can notify one or more ESLs of the new channel map to be used for future communications with the access point.

In some cases, an ESL may lose synchronization with (e.g., due to being out of communications range) a current access point for which the ESL is associated. Such a loss in synchronization may interrupt the management entity's ability to control the ESL and the ESL's ability to report to the management entity. After determining a network outage (e.g., caused by the loss of synchronization), the ESL may perform an onboarding procedure to reestablish synchronization with an access point. PAwR allows BLE peripheral devices (e.g., ESLs) to perform an onboarding procedure to synchronize with a central device (e.g., an access point) and, as such, be able to respond to periodic transmissions from the central device. For example, for an onboarding procedure in a retail setup (e.g., within a retail store or warehouse environment), an access point can act as a central device, and ESLs can act as peripheral devices. When the ESLs are powered, the ESLs can scan to receive a wake up packet (WUP) from the access point. The WUP can contain advertisement parameters for the ESLs. Upon receiving the WUP from the access point, the ESLs can transmit advertisement messages (e.g., a connectable advertisement (CAP)) on a legacy channel based on parameters (e.g., interval and duration parameters) received within the WUP. The access point can scan to receive the CAPs from the ESLs, and then create a generic attribute profile (GATT) connection with one of the advertising ESLs to perform onboarding of that ESL. The onboarding process involves the transfer of periodic advertisement synchronization transfer (PAST) information, where an access point can share its PAwR timing with the ESL. When multiple access points receive a CAP from an ESL, the access points can report the received CAP to the management entity. The management entity can then shortlist one of the access points to onboard the ESL.

A system, such as an enterprise resource planning (ERP) system (e.g., for asset tracking, monitoring, and/or supply chain management purposes, such as in a retail store or warehouse environment), may include one or more wireless communication devices that are controlled by a network entity. For example, a system may include one or more peripheral devices (e.g., wireless communication devices, such as in the form of ESLs) that are controlled by a network entity (e.g., an ERP server) via at least one network device (e.g., an access point). In one or more examples, to facilitate control by the network entity (e.g., the ERP server), each peripheral device (e.g., ESL) may have a wireless connection (e.g., a BLE connection or other connection) to the network device (e.g., the access point) that is communicatively connected to the network entity (e.g., via the Internet, such as wirelessly, via an Ethernet connection, etc.). In some cases, commands from the network entity (e.g., the ERP server) may be wirelessly transmitted to the peripheral devices (e.g., ESLs) by the network device (e.g., the access point). Responses or information from the peripheral devices may also be received by the network device, and provided by the network device to the network entity (e.g., by the access point to the ERP server).

The peripheral devices in the system may include a plurality of ambient internet of things (IoT) devices (as examples of wireless communication devices or peripheral devices), which may each be in the form of a low cost, batteryless, energy harvesting tag. One or more of the ambient IoT devices (e.g., tags) can each be attached to an asset located within a location (e.g., a retail store, a warehouse, etc.) for asset tracking, monitoring, and/or supply chain management purposes. Devices, such as devices for energizing (e.g., which may be referred to as “energizing devices”, “energizers”, or “readers”), can interrogate, scan, read, probe, and/or energize the ambient IoT devices. Such devices can be in the form of mobile devices (e.g., smart phones, tablet computers, handheld reader devices, etc.), robots, forklifts, or other devices.

The ambient IoT devices (e.g., being batteryless) may be powered by harvesting energy (e.g., power) from signals (e.g., energizing signals, RF signals, sweeping beams, or energizing waveforms) transmitted from the devices (such as energizing devices). After being energized, the ambient IoT devices can each transmit a response signal including some identifying information (e.g., metadata) that is unique to each ambient IoT device. Near field communication (NFC) tags can support communication as well. An ERP server may store and maintain a database of information pertaining to the ambient IoT devices (e.g., information related to their capabilities and last known locations).

Smart retail use cases often employ ambient IoT devices (e.g., tags) and energizing devices for indoor navigation, asset tracking using the ambient IoT devices, and inventory management. Given a large number of ambient IoT devices (e.g., tags) located within an indoor environment (e.g., a store or warehouse), there can be a large amount of interference on the uplink channel (e.g., towards the ESLs and access points). This interference problem can be exacerbated by the fact that ambient IoT devices (e.g., tags) typically do not have a complete receiver module and, as such, are not able to receive scheduling information or payload information on the downlink channel. As such, improved systems and techniques for scheduling of ambient IoT devices (e.g., in smart retail) such that there is a reduction in interference on the uplink channel can be beneficial.

In one or more aspects of the present disclosure, systems, apparatuses, methods (also referred to as processes), and computer-readable media (collectively referred to herein as “systems and techniques”) are described herein that provide solutions for uplink scheduling of computing devices, such as ambient Internet of things (IoT) devices (e.g., transmit-only ambient IoT tags). Such systems and techniques can be used for various applications, such as in smart retail, for smart warehousing solutions, for automotive applications, among other applications or use cases.

Various aspects relate generally to wireless communications. Some aspects more specifically relate to systems and techniques that provide solutions for scheduling ambient IoT devices (e.g., tags) for a reduction in interference on the uplink channel. In one or more aspects, for a reduction of interference on the uplink channel, the systems and techniques provide solutions that involve pre-configured ambient IoT devices (e.g., tags) whose transmission behavior (e.g., frequency channel and/or time for transmission) is hard-wired prior to their deployment, criteria for forming a group of ambient IoT devices (e.g., tags) for interference mitigation, and on-the-fly reconfiguration of frequency behavior of ambient IoT devices (e.g., tags) by using a waveform pattern of an energizer transmission or using a configuration of a switch. In one or more examples, transmissions of ambient IoT devices can be multiplexed in the time domain or the frequency domain. In some examples, an ambient IoT device of a group of ambient IoT devices may be pre-configured (e.g., preprogrammed or hardwired during the manufacturing phase) to regulate its transmissions. In some examples, ambient IoT devices can be grouped together within a group based on their area of deployment, product type, batch identification, mode of transportation, priority, and/or susceptibility to interference based on the store layout. In one or more examples, an ambient IoT device may be reconfigured (e.g., programmed) on-the-fly using a pre-known waveform pattern of an energizing transmission to operate in a certain mode of operation. A lookup table including different waveform patterns for the energizing transmissions corresponding to the different modes of operation can be stored (e.g., programmed) within the ambient IoT device prior to deployment. In some examples, a series of ambient IoT devices may be sequentially programmed (e.g., reconfigured) by energizing transmissions transmitted from an energizing device to operate in non-interfering modes of operation, based on different criteria. In one or more examples, the different modes of operation for an ambient IoT device may be selected by toggling a physical mechanical switch incorporated within the ambient IoT device itself.

In one or more examples, during operation for wireless communications, a computing device (e.g., an ambient IoT device) can receive an energizer transmission from an energizing device. The computing device can store energy from the energizer transmission. The computing device can transmit, based on the stored energy, a response signal using at a particular frequency channel and/or a particular time. In one or more examples, the computing device may be configured to transmit using the particular frequency channel and/or the particular time, based on a type of the computing device, the energizer transmission, or a configuration of a switch associated with the computing device. In one or more examples, based on the type of the computing device, the computing device can be pre-configured to transmit with a certain duty cycle, every n^{th} number time slot of a time grid, and/or a certain time offset within a time slot of the time grid. In some examples, the computing device may have a physical characteristic indicating the type of the computing device. In one or more examples, the computing device may be pre-configured to transmit the response signal with an orthogonal preamble sequence.

In one or more examples, the computing device can be within a group of computing devices. In some examples, computing devices within the group of computing devices are included within the group based on one or more grouping factors. Grouping factors can include the computing devices being a same area of deployment, being of a same product type, having a same batch identification, being transported together, having a same priority, being susceptible to interference based on a store layout, any combination thereof, and/or other grouping factors. In some examples, the area of deployment may be on a certain shelf or within a certain aisle. In one or more examples, when the computing devices within the group of computing devices have a higher priority than other computing devices within other groups, the computing devices within the group of computing devices can be pre-configured to transmit more frequently than the other computing devices within the other groups. In some examples, the computing device may be reconfigured to transmit using the particular frequency channel and/or the particular time based on a waveform pattern of the energizer transmission. In some examples, the waveform pattern may be an ON/OFF pattern. In one or more examples, the computing device can be pre-configured to have stored a plurality of different waveform patterns including the waveform pattern. In one or more examples, the computing device may be reconfigured to transmit using the particular frequency channel and/or the particular time based on the configuration of the switch associated with the computing device.

Particular aspects of the subject matter described in this disclosure can be implemented to realize one or more of the following potential advantages. In some examples, the systems and techniques can provide for a reduction in interference on an uplink channel by configuring the transmissions of ambient IoT devices (e.g., tags) to not interfere with one another. This reduction in interference on the uplink channel can allow for less signal congestion on the channel and an improvement in wireless communications.

Additional aspects of the present disclosure are described in more detail below.

As used herein, the term “RF signal” includes an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

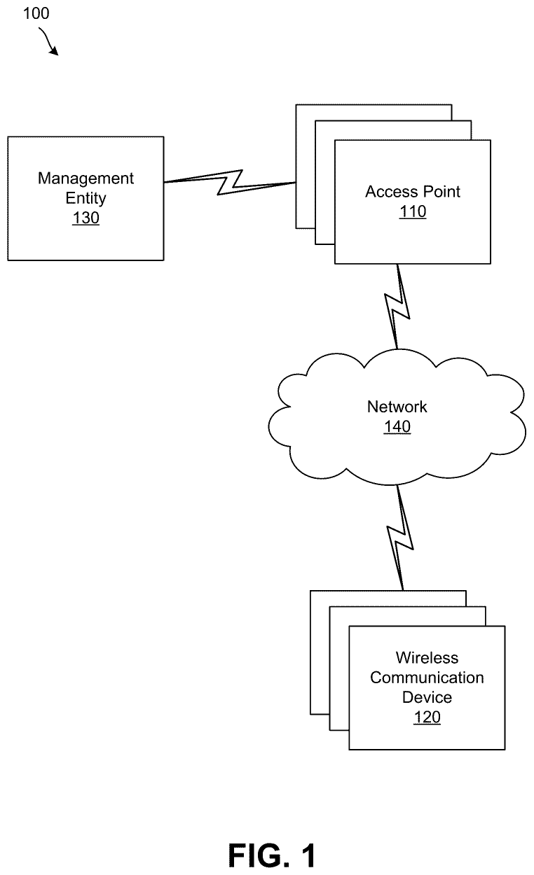

According to various aspects, FIG. 1 is a diagram of an example environment 100 in which systems and/or methods described herein may be implemented. As shown in FIG. 1, the environment 100 may include at least one access point (AP) 110 (e.g., a network device), at least one wireless communication device 120 (e.g., at least one ESL), a management entity (ME) 130 (e.g., a network entity), and a network 140. Devices of the environment 100 may interconnect via wired connections, wireless connections, or a combination of wired and wireless connections.

The access point 110 may include one or more devices capable of receiving, generating, storing, processing, providing, and/or routing information associated with access point synchronization and/or handover, as described elsewhere herein. The access point 110 may include a communication device and/or a computing device. The access point 110 may be configured to transmit beacons (e.g., BLE beacons), as well as to scan and locate other devices (e.g., other devices communicating using BLE protocols).

The wireless communication device 120 may include one or more devices capable of receiving, generating, storing, processing, and/or providing information associated with access point synchronization and/or handover, as described elsewhere herein. The wireless communication device 120 may include a communication device and/or a computing device. In some aspects, the wireless communication device 120 may be, may include, or may be included in an electronic shelf label (ESL).

The management entity 130 includes one or more devices capable of receiving, generating, storing, processing, providing, and/or routing information associated with access point synchronization and/or handover, as described elsewhere herein. The management entity 130 may include a communication device and/or a computing device. For example, the management entity 130 may include a server, such as an application server, a client server, a web server, a database server, a host server, a proxy server, a virtual server (e.g., executing on computing hardware), or a server in a cloud computing system. In some aspects, the management entity 130 includes computing hardware used in a cloud computing environment. The management entity 130 may provide control of a system (e.g., an ESL system) that includes the access point(s) 110, the wireless communication device(s) 120, and/or the device(s) 130. The access point(s) 110 may be communicatively connected to the management entity 130 via a network (not shown), such as the Internet.

The network 140 may include one or more wireless networks. For example, the network 140 may include a personal area network (e.g., a Bluetooth network). The network 140 enables communication among the devices of environment 100.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

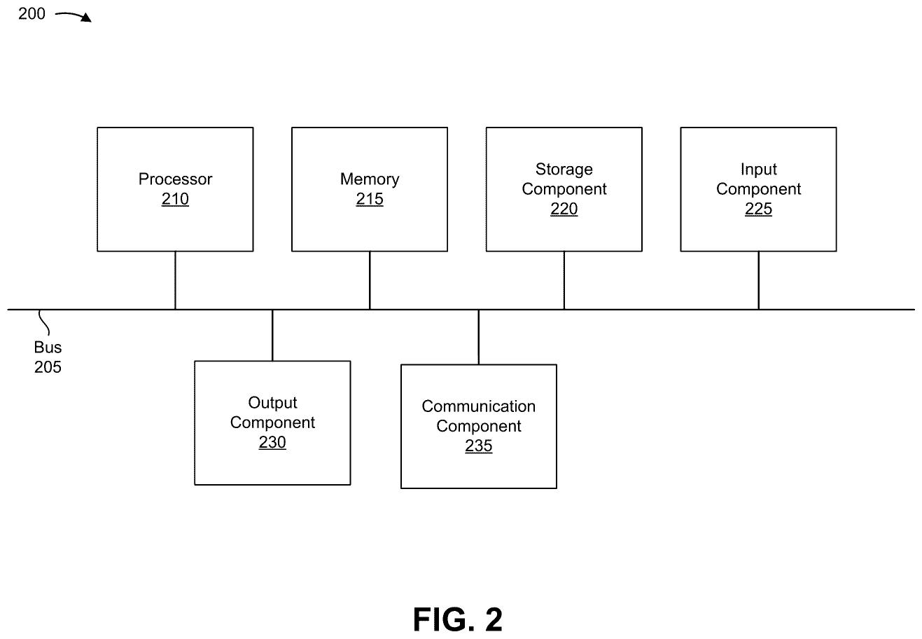

FIG. 2 is a diagram illustrating example components of a device 200, in accordance with the present disclosure. Device 200 may correspond to access point 110, wireless communication device 120 (e.g., an ESL), and/or management entity 130. In some aspects, access point 110, wireless communication device 120, and/or management entity 130 may include one or more devices 200 and/or one or more components of device 200. As shown in FIG. 2, device 200 may include a bus 205, a processor 210, a memory 215, a storage component 220, an input component 225, an output component 230, and/or a communication component 235.

Bus 205 may include a component that permits communication among the components of device 200. Processor 210 may be implemented in hardware, firmware, or a combination of hardware and software. Processor 210 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some aspects, processor 210 may include one or more processors capable of being programmed to perform a function. Memory 215 may include a random access memory (RAM), a read only memory (ROM), and/or another type of dynamic or static storage device (e.g., a flash memory, a magnetic memory, and/or an optical memory) that stores information and/or instructions for use by processor 210.

Storage component 220 can store information and/or software related to the operation and use of device 200. For example, storage component 220 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 225 may include a component that permits device 200 to receive information, such as via user input (e.g., a touch screen display, a keyboard, a keypad, a mouse, a button, a switch, and/or a microphone). Additionally, or alternatively, input component 225 may include a component for determining a position or a location of device 200 (e.g., an indoor location component or system that can be based on a plan-o-gram of an environment in which the device 200 is located, a global positioning system (GPS) component, a global navigation satellite system (GNSS) component, any combination thereof, and/or other location component) and/or a sensor for sensing information (e.g., an accelerometer, a gyroscope, an actuator, or another type of position or environment sensor). Output component 230 can include a component that provides output information from device 200 (e.g., a display, a speaker, a haptic feedback component, and/or an audio or visual indicator).

Communication component 235 may include one or more transceiver-like components (e.g., a transceiver and/or a separate receiver and transmitter) that enables device 200 to communicate with other devices, such as via a wired connection, a wireless connection, or a combination of wired and wireless connections. Communication component 235 may permit device 200 to receive information from another device and/or provide information to another device. For example, communication component 235 may include an Ethernet interface, an optical interface, a coaxial interface, an infrared interface, a radio frequency interface, a universal serial bus (USB) interface, a wireless local area interface (e.g., a Wi-Fi interface or a BLE interface), and/or a cellular network interface.

Communication component 235 may include one or more antennas for receiving wireless radio frequency (RF) signals transmitted from one or more other devices, cloud networks, and/or the like. The antenna may be a single antenna or an antenna array (e.g., antenna phased array) that can facilitate simultaneous transmit and receive functionality. The antenna may be an omnidirectional antenna such that signals can be received from and transmitted in all directions. The wireless signals may be transmitted via a wireless network. The wireless network may be any wireless network, such as a cellular or telecommunications network (e.g., 3G, 4G, 5G, etc.), wireless local area network (e.g., a WiFi network), a Bluetooth™ network, and/or other network.

The one or more transceiver-like components (e.g., a wireless transceiver) of the communication component 235 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle selection and conversion of the wireless signals into a baseband or intermediate frequency and can convert the RF signals to the digital domain.

In some cases, a CODEC may be implemented (e.g., by the processor 210) to encode and/or decode data transmitted and/or received using the one or more wireless transceivers. In some cases, encryption-decryption may be implemented (e.g., by the processor 210) to encrypt and/or decrypt data (e.g., according to the Advanced Encryption Standard (AES) and/or Data Encryption Standard (DES) standard) transmitted and/or received by the one or more wireless transceivers.

In some aspects, device 200 may represent an ESL. The ESL may include a battery in addition to the aforementioned components. In some aspects, the output component 230 of the ESL may be an electronic paper (e-paper) display or a liquid crystal display (LCD).

Device 200 may perform one or more processes described herein. Device 200 may perform these processes based on processor 210 executing software instructions stored by a non-transitory computer-readable medium, such as memory 215 and/or storage component 220. A computer-readable medium is defined herein as a non-transitory memory device. A memory device includes memory space within a single physical storage device or memory space spread across multiple physical storage devices.

Software instructions may be read into memory 215 and/or storage component 220 from another computer-readable medium or from another device via communication component 235. When executed, software instructions stored in memory 215 and/or storage component 220 may cause processor 210 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

The number and arrangement of components shown in FIG. 2 are provided as an example. In practice, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

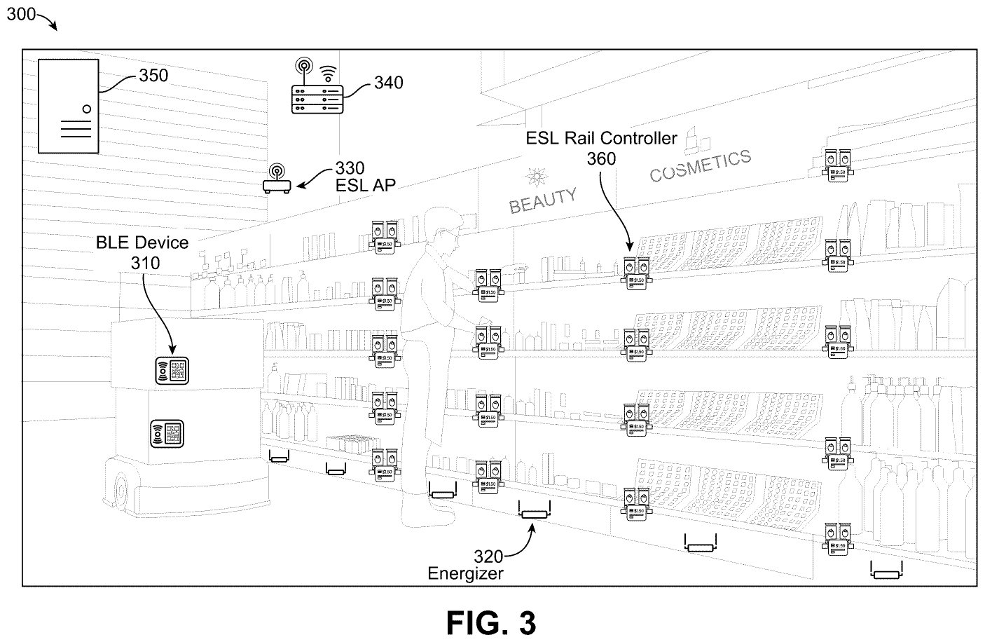

As previously mentioned, a system, such as an enterprise resource planning (ERP) system (e.g., for asset tracking, monitoring, and/or supply chain management purposes, such as in a retail store, a warehouse environment, a network or system of vehicles, etc.), can include one or more wireless communication devices that are controlled by a network entity. For example, a system may include one or more peripheral devices (e.g., wireless communication devices, such as wireless communication devices 120 of FIG. 1, for example in the form of ESLs) that are controlled by a network entity (e.g., an ERP server, such as network entity 350 of FIG. 3) via at least one network device (e.g., an access point, such as access point 110 of FIG. 1). In one or more examples, to facilitate control by the network entity (e.g., the ERP server), each peripheral device (e.g., ESL) can have a wireless connection (e.g., a BLE connection or other connection) to the network device (e.g., the access point) that is communicatively connected to the network entity (e.g., via the Internet, such as wirelessly, via an Ethernet connection, etc.). In some cases, commands from the network entity (e.g., the ERP server) can be wirelessly transmitted to the peripheral devices (e.g., ESLs) by the network device (e.g., the access point). Responses or information from the peripheral devices can also be received by the network device, and provided by the network device to the network entity (e.g., by the access point to the ERP server).

The peripheral devices in the system can include a plurality of ambient IoT devices (as examples of wireless communication devices or peripheral devices), which may each be in the form of a low cost, batteryless, energy harvesting tag. One or more of the ambient IoT devices (e.g., ambient IoT tags) may each be attached to an asset located within a location (e.g., a retail store, a warehouse, etc.) for asset tracking, monitoring, and/or supply chain management purposes. Devices, such as devices for energizing (e.g., which may be referred to as “energizing devices”, “energizers”, or “readers”), may interrogate, scan, read, probe, and/or energize the ambient IoT devices. Such devices may be in the form of mobile devices (e.g., smart phones, tablet computers, handheld reader devices, etc.), robots, forklifts, or other devices.

The ambient IoT devices, being batteryless, can be powered by harvesting energy (e.g., power) from signals (e.g., energizing signals, RF signals, sweeping beams, or energizing waveforms) transmitted from the devices (e.g., energizing devices). After being energized, the ambient IoT devices may each transmit a response signal including some identifying information (e.g., metadata) that is unique to each ambient IoT device. NFC tags may support communication as well. An ERP server can store and maintain a database of information pertaining to the ambient IoT devices (e.g., information related to their capabilities and last known locations).

In one or more aspects, an ERP system infrastructure (e.g., including energizing devices) can be utilized to trigger ambient IoT devices to send response signals including their respective identifying information. In one or more examples, ambient IoT devices of an ERP system infrastructure may be configured to transmit beacon frames (e.g., response signals, which may include identifying information associated with the ambient IoT devices).

FIG. 3 shows an example of system infrastructure. In particular, FIG. 3 is a diagram illustrating an example of an ERP system infrastructure 300. In FIG. 3, the infrastructure 300 is shown to be located within a retail store. The infrastructure is shown to include a network entity 350 (e.g., in the form of an ERP server or cloud server, which may be located remotely from the retail store), a network entity 340 (e.g., in the form of an edge server or gateway node, which may be located within the retail store), a network device 330 (e.g., an access point, which may be located within the retail store), ambient IoT devices 310 (e.g., energy harvesting BLE tags that are each associated with a parcel), energizing devices 320 (e.g., energizers mounted on the shelving units within the retail store), and wireless communication devices 360 (e.g., in the form of ESLs that are mounted on the shelving units, where the ESLs are powered and controlled by an electric rail mounted within the shelving units).

In one or more aspects, the energizing devices 320 (e.g., energizers mounted on a shelf, mobile devices, such as a smart phone, a robot, a forklift, etc.) may have one or more capabilities. In one or more examples, the energizing devices 320 may have a capability of supporting RFID technology, which may include the ability to read and scan an ambient IoT device 310 (e.g., in the form of an RFID tag), and include the ability to support communications using one or more frequency bands related to RFID technology, such as low frequency (LF), high frequency (HF), near field communication (NFC) frequency, and ultra-high frequency (UHF). In some examples, the energizing devices 310 may have an energizing capability, which can include the ability to energize an ambient IoT device 310 and to instruct the ambient IoT device 310 to communicate (e.g., via a broadcast or a unicast) with another device (e.g., communicate information about a particular item to an access point, such as for inventory purposes). In one or more examples, the energizing devices 320 may have a capability to support beamforming (e.g., a beamforming capability to be able to form an antenna beam and scan the beam towards a particular ambient IoT device 310), such as for the purpose of interrogating the ambient IoT device 310.

In one or more examples, the energizing devices 320 may have a capability to support radio communications, such as radio frequency (RF) communications (e.g., using cellular, satellite, Wi-Fi, and/or Bluetooth communications). For example, the energizing devices 320 may be able to receive transmissions (e.g., RF signal transmissions) from one or more ambient IoT devices 310 (e.g., each in the form of a tag), such as for the purpose of relaying the received information to a network device 330 (e.g., access point), a network entity 340 (e.g., an edge server) and/or an ERP system (e.g., network entity 350, such as an ERP server).

In some examples, the energizing devices 320 may have a capability of including a camera for capturing images and/or video of the surrounding environment (e.g., within the retail store or warehouse). The energizing devices 320 may receive information (e.g., about a product associated with an ambient IoT device 310) via images taken by the camera of the local environment.

In one or more examples, the energizing devices 320 may have a capability of having transparency, which may include an ability to share information associated with one or more ambient IoT devices 310, which may each be in the form of a tag, with an external server, such as the ERP system (e.g., network entity 350, such as an ERP server). In some examples, the energizing devices 320 may have the capability to share information (e.g., prices, expiration dates, and/or online reviews related to the items associated with the ambient IoT devices 310) to a user or a store employee by displaying the information on a graphical user interface (GUI), which may be implemented within the energizing devices 320. In one or more examples, when an energizing device 320 is able to share information associated with one or more ambient IoT devices 310, there may be an expected latency (e.g., an expected amount of delay in time) in the energizing device 320 delivering the information to the ERP system (e.g., network entity 350, such as an ERP server).

In one or more aspects, ambient IoT devices 310, which may each be in the form of a tag, may have one or more capabilities. In one or more examples, the ambient IoT devices 310 may be part of a larger system, such as a system that includes wireless communication devices 360 (e.g., ESLs) and/or rail controllers, which may each be equipped with wireless radios (e.g., RF radios) and/or cameras.

In one or more examples, the ambient IoT devices 310 may have one or more of the same capabilities as previously mentioned for the energizing devices 320, except for the energizing and beamforming capabilities. For example, the ambient IoT devices 310 may have capabilities including the ability to support RFID technology (e.g., which can include the ability to harvest energy from received signals (energizer signals or transmissions) from energizing devices 320 and to transmit identifying information after being sufficiently energized with power), the ability to operate as a radio (e.g., the ability to receive transmissions from energizing devices 320 and to transmit signals to the energizing devices 320 and/or to the wireless communication devices 360), the ability to operate as a camera, and/or the ability to operate with transparency (e.g., by sharing identifying information for itself with energizing devices 320).

In one or more aspects, the energizing devices 320 may have different states or modes of operation. In the one or more examples, the different states or modes of operation may include an omnidirectional state or mode, a directional state or mode, a beam sweep state or mode, and/or an inactive state or mode. In one or more examples, the omnidirectional state or mode may be a state or mode where the energizing device 320 scans one or more antennas associated with the energizing device 320 in all directions (e.g., to form an omnidirectional antenna beam pattern). In some examples, the directional state or mode may be a state or mode where the energizing device 320 forms an antenna beam and scans the beam in a specific direction (e.g., analog beamforming). In one or more examples, the beam sweep state or mode may be a state or mode where the energizing device 320 forms a set of antenna beams, where each beam is a directional beam, and scans the set of beams. In some examples, the inactive state or mode may be a state or mode where the energizing device 320 is not operational (e.g., the energizing device is powered off).

In one or more aspects, the energizing devices 320 may jointly perform beam sweeping over a certain region and trigger the ambient IoT devices 310 (e.g., to send response signals including identifying information) located within that region. In one or more examples, the energizing devices 320 can trigger the ambient IoT devices 310, based on a type of the ambient IoT devices 310, a region for location of the ambient IoT devices 310, a region centered around a specific location for the ambient IoT devices 310, on certain period of time, or a certain number of transmissions. In one or more examples, the beam sweeping may be performed in an efficient non-overlapping manner such that different energizing devices 320 do not energize the same set of the ambient IoT devices 310 (e.g., tags).

During operation of the infrastructure 300 of FIG. 3 within a particular environment (e.g., a retail environment, a warehouse, an automotive environment with multiple vehicles, among other use cases), the energizing devices 320 can send (e.g., transmit) energizer signals (e.g., energizer transmissions) to the ambient IoT devices 310. The ambient IoT devices 310 can receive the energizer signals and harvest energy from the energizer signals to energize themselves. After the ambient IoT devices 310 have harvested enough energy to be able to transmit, the ambient IoT devices 310 (e.g., tags) can send (e.g., transmit) beacon frames. In one or more examples, the ambient IoT devices 310 can be configured to transmit beacon frames for a certain period of time or for a certain number of transmissions, based on a waveform of the received energizer signals (e.g., energizer transmission) transmitted from the energizing devices 320.

In one or more examples, the wireless communication devices 360 (e.g., ESLs), which are located within the vicinity of the ambient IoT devices 310 (e.g., tags), can receive the beacon frames transmitted from the ambient IoT devices 310 (e.g., tags). In some examples, receivers (e.g., associated with the wireless communication devices 360) may receive the beacon frames, may obtain information from the beacon frames (e.g., information related to the ambient IoT devices 310 themselves, such as unique identifying information, and/or information related to items or product associated with the ambient IoT devices 310), and may obtain measurements (e.g., signal strength measurements, such as RSSI) of the received beacon frames. In response to receiving the beacon frames, the receivers may not perform an interrogation itself, but rather may relay the information within and/or associated with (e.g., measurements, such as the RSSI) the beacon frames to the ERP system (e.g., network entity 350, such as an ERP server), for example via the network device 330 (e.g., access point) and the network entity 340 (e.g., an edge server).

In some examples, the ERP system (e.g., network entity 350, such as an ERP server), the network device 330 (e.g., access point) and/or the network entity 340 (e.g., an edge server) may determine (e.g., compute) a position (e.g., an estimated location) for an ambient IoT device 310 based on signal strengths (e.g., RSSIs) measured by a plurality of wireless communication devices 360 (e.g., ESLs) of signals (e.g., beacons) transmitted from that ambient IoT device 310.

For example, for a given ambient IoT device 310, let r₁≥ r₂≥ . . . r_{M} denote the RSSI values for M number of wireless communication devices 360 (e.g., ESLs) in descending order. The position estimate for the ambient IoT device 310 can then be given by the weighted average of the known positions of the wireless communication devices 360 (e.g., ESLs), where the weights may be a function of the RSSI values. As such, the position for the ambient IoT device 310 may be determined by using the following equations:

$$\hat{P} = \frac{{\sum }_{k = 1}^{N} {w}_{k} \cdot {P}_{k}}{{\sum }_{k = 1}^{N} {w}_{k}} \qquad [ equation 1 ]$$

where N is the number of wireless communication devices 360 (e.g., ESLs), wₖ are the weights for the wireless communication devices 360 (e.g., ESLs), and Pₖ are the known positions (e.g., ground truth locations) for the wireless communication devices 360 (e.g., ESLs). The weights wₖ can be set to any suitable value. N is a subset of M. N may be an empirical term, which may be preset to some desired value.

As previously mentioned, in ESL systems, PAs are often utilized to provide regular and predictable payload transmissions from a central device (e.g., which may be in the form of a network device, such as an access point) to one or more peripheral devices (e.g., which may each be in the form of a wireless communication device, such as an ESL). PAs can be used to issue information from a central device to multiple peripheral devices, which may be within one or more groups of peripheral devices. PAs are generally unidirectional (e.g., unidirectional transmissions) such that PAs are transmitted only one-way from a central device to one or more peripheral devices.

Periodic Advertisement with Response (PAwR) was introduced to ESL systems to provide bidirectionality (e.g., bidirectional transmissions between a central device and one or more peripheral devices). Peripheral devices synchronized within a group of peripheral devices can be addressed by a central device on a synchronized channel (e.g., a synchronized frequency channel between the central device and the peripheral devices) whenever the central device determines to send (e.g., transmit) a request (e.g., a PA containing a synchronization message transmitted on the synchronized channel) to the peripheral devices. If a response from a peripheral device is expected by the central device (e.g., the synchronization message from the central device requests a response from a specific peripheral device), the particular peripheral device will respond in a specific response slot, based on where the peripheral device appeared within a sequence contained within the synchronization message transmitted by the central device.

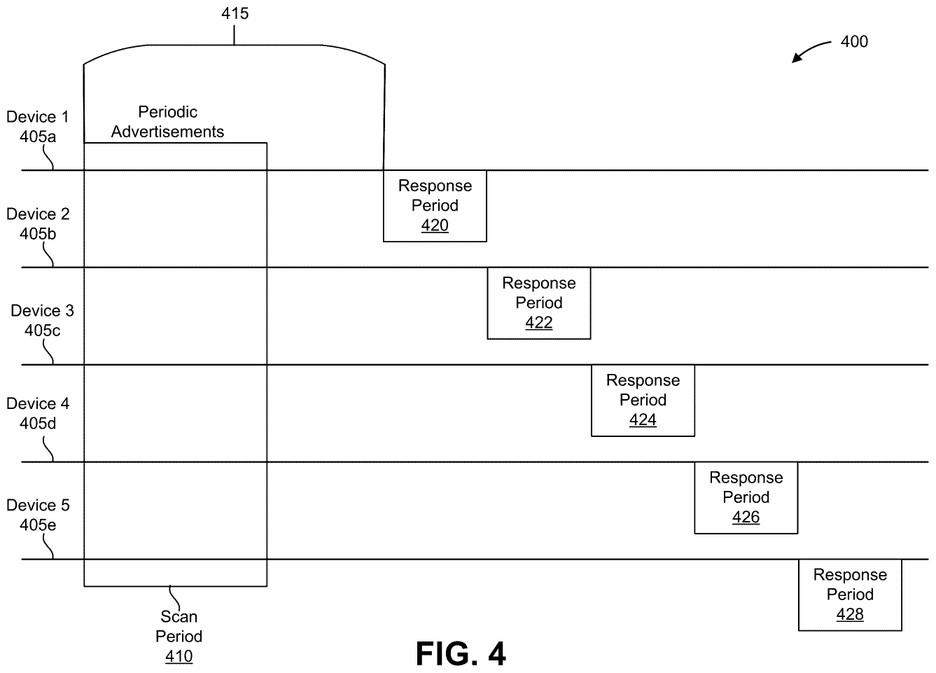

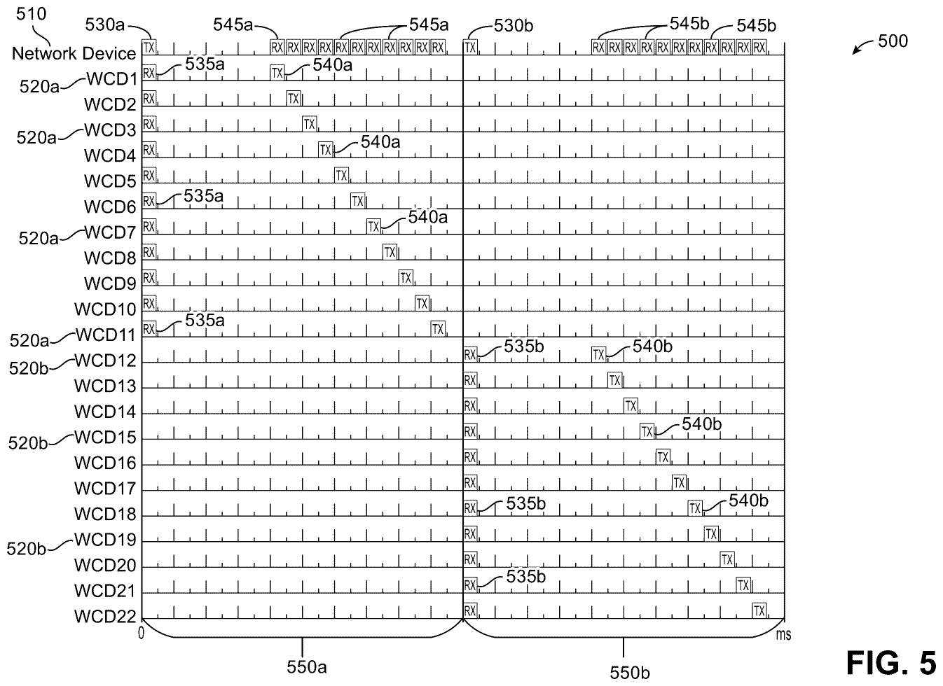

FIGS. 4 and 5 show signaling diagrams illustrating examples of PAwR in an ESL system. In particular, the signaling diagram 400 of FIG. 4 shows an example PAwR for a group of wireless network devices (e.g., device 1 405a, device 2 405b, device 3 405c, device 4 405d, and device 5 405c), and the signaling diagram of FIG. 5 shows an example PAwR for two groups of wireless communication devices 520a, 520b (e.g., a first group including ESL1 to ESL 11, and a second group including ESL 12 to ESL 22). Specifically, FIG. 4 is a signal timing diagram illustrating a portion of a communication between an access point (e.g., access point 110) and wireless communication devices 120 (e.g., ESLs). With reference to FIG. 1, the signal sequence illustrated in FIG. 4 may be implemented by one or more of the communication connections, access points 110, and/or wireless communication devices 120 of FIG. 1.

The devices (e.g., device 1 405a, device 2 405b, device 3 405c, device 4 405d, and device 5 405c) of FIG. 4 may be selected from wireless communication devices 120 of FIG. 1, and may each receive a periodic advertisement (PA) in a scan period 410. The scan period 410 may occur in regularly scheduled intervals and may be repeated periodically such that the devices (e.g., device 1 405a, device 2 405b, device 3 405c, device 4 405d, and device 5 405c) can awaken to scan for messages during this repeated scan period 410. An access point (e.g., access point 110 of FIG. 1) may provide periodic advertisements (PAS) via broadcast or multi-cast to the devices (e.g., device 1 405a, device 2 405b, device 3 405c, device 4 405d, and device 5 405c) in the scan period 410. For an access point (e.g., access point 110 of FIG. 1), the scan period 410 can be its primary transmission period. In some cases, the scan period 410 may not be a fixed time because the access point (e.g., access point 110 of FIG. 1) may send different lengths of data from the start of the scan period 410.

The transmission may include multiple advertisements in a train. One or more portions of the advertisements may be directed to one or more of the devices (e.g., device 1 405a, device 2 405b, device 3 405c, device 4 405d, and device 5 405c). The devices (e.g., device 1 405a, device 2 405b, device 3 405c, device 4 405d, and device 5 405e) may decode or filter the messages intended for each specific device and transmitted during the period when all devices are receiving. In this way, the devices (e.g., device 1 405a, device 2 405b, device 3 405c, device 4 405d, and device 5 405e) may be reprogrammed, updated, and/or sent requests from an access point (e.g., access point 110 of FIG. 1) or relayed from another device (e.g., management entity 130 of FIG. 1) through the access point (e.g., access point 110 of FIG. 1). The periodic advertisement (PA) from the access point (e.g., access point 110 of FIG. 1) may set a response period for one or more of the devices (e.g., device 1 405a, device 2 405b, device 3 405c, device 4 405d, and device 5 405c).

As illustrated, the devices (e.g., device 1 405a, device 2 405b, device 3 405c, device 4 405d, and device 5 405e) are each assigned a response period 420, 422, 424, 426, 428 in the time after the scan period 410. The response periods 420, 422, 424, 426, 428 for the ESL transmissions occur in a time division multiple access (TDMA) manner. In some cases, the assignment of the response period to a particular device may not be permanent. In some aspects, the assignment may be inferred from a payload of a synchronization message. The first response period 420 may begin following an idle time 415 after the scan period 410, with the idle period being long enough to provide the transmitter device an opportunity to do other Bluetooth related activities. The assigned response periods may also be limited to or designate a particular frequency of the channels on which to respond. For example, in FIG. 4, device 1 405a is assigned response period 420, device 2 405b is assigned response period 422, device 3 405c is assigned response period 424, device 4 405d is assigned response period 426, and device 5 405e is assigned response period 428. The access point (e.g., access point 110 of FIG. 1) may store attributes of the devices (e.g., device 1 405a, device 2 405b, device 3 405c, device 4 405d, and device 5 405c), including whether a device is able to transmit or respond. The PA signaling followed by responses can be referred to as periodic advertisement with multiple responses (PAwMR).

For example, device 3 405c (e.g., wireless communication device 120 of FIG. 1) may be an ESL and may receive a price update in a PA from the access point (e.g., access point 110 of FIG. 1) in scan period 410. The PA received at device 3 405c may include a designated start time for the response period 424 or may include a schedule of response start times for devices including device 3 405c. The response by device 3 405c to the access point (e.g., access point 110 of FIG. 1) may include an acknowledgement, a status code, and/or other information such as battery life, received signal strength, and/or an error notification. The response by device 3 405c may include information to be relayed to another device by the access point (e.g., access point 110 of FIG. 1). The response may include a packet with a header and may conform to any of the Bluetooth protocols. A response may be transmitted in a data channel of the Bluetooth protocol to the access point (e.g., access point 110 of FIG. 1). Both the PA and the responses from all of the devices (e.g., device 1 405a, device 2 405b, device 3 405c, device 4 405d, and device 5 405c) may use channels of the Bluetooth protocol.

A device (e.g., device 5 405e) that has been assigned a response period may not respond and may determine that it has nothing to signal. In other words, the devices (e.g., device 1 405a, device 2 405b, device 3 405c, device 4 405d, and device 5 405e) may determine what response, if any, is required and may or may not respond to a request sent from the access point (e.g., access point 110 of FIG. 1). The response periods 420, 422, 424, 426, 428 may be assigned based on a request for such a period in an open transmission time, the request being sent to the access point (e.g., access point 110 of FIG. 1). The response periods 420, 422, 424, 426, 428 may be assigned based on which devices have been requested by the access point (e.g., access point 110 of FIG. 1) to send data or acknowledgements. The PA messages and responses may be frequency-hopped, time synchronized channels, and/or extended channels of the advertisement channels in Bluetooth.

As previously mentioned, FIG. 5 shows an example PAwR for two groups of wireless communication devices (WCDs) 520a, 520b (e.g., a first group including ESL1 to ESL 11, and a second group including ESL 12 to ESL 22). In particular, FIG. 5 is a signaling diagram illustrating an example of communication transmissions 500 between a network device 510 (e.g., a central device, which may be an access point) and two groups of wireless communication devices 520a, 520b (e.g., peripheral devices, which may be ESLs). With reference to FIG. 1, the signal sequence illustrated in FIG. 5 may be implemented by one or more of the communication connections, access points 110, and/or wireless communication devices 120 of FIG. 1.

In FIG. 5, the signaling diagram is shown in the form of a graph (e.g., a time grid, which may be predetermined) with an x-axis denoting time in milliseconds (ms) and a y-axis denoting specific wireless communication devices 520a, 520b (e.g., ESL1, ESL 2, ESL 3, ESL 4, ESL 5, ESL 6, ESL 7, ESL 8, ESL 9, ESL 10, ESL 11, ESL 12, ESL 13, ESL 14, ESL 15, ESL 16, ESL 17, ESL 18, ESL 19, ESL 20, ESL 21, and ESL 22). In particular, the x-axis of the graph of FIG. 5 denotes time starting from zero (0) ms. The time can be divided into two subframes 550a, 550b. As such, the two subframes 550a, 550b may include a first subframe 550a and a second subframe 550b. In one or more examples, there may be more or less than two subframes 550a, 550b as is shown in FIG. 5, and/or each subframe 550a, 550b may be longer or shorter than as shown in FIG. 5.

In one or more examples, the wireless communication devices 520a, 520b (e.g., peripheral devices) may be assigned (e.g., by the network device 510 and/or by a network entity, such as a management entity) to different groups (e.g., two groups) of wireless communication devices 520a, 520b. For example, wireless communication devices 520a (e.g., ESL1, ESL 2, ESL 3, ESL 4, ESL 5, ESL 6, ESL 7, ESL 8, ESL 9, ESL 10, and ESL 11) may be assigned to a first group (e.g., group 1), and wireless communication devices 520b (e.g., ESL 12, ESL 13, ESL 14, ESL 15, ESL 16, ESL 17, ESL 18, ESL 19, ESL 20, ESL 21, and ESL 22) may be assigned to second group (e.g., group 2).

In FIG. 5, during operation for PAwR, at time 0 ms for the first subframe 550a of time, the network device 510 (e.g., a central, such as an AP) may transmit 530a to a first group (e.g., group 1) of wireless communication devices 520a (e.g., ESL 1, ESL 2, ESL 3, ESL 4, ESL 5, ESL 6, ESL 7, ESL 8, ESL 9, ESL 10, and ESL 11) a PA containing a synchronization message (e.g., an AP synchronization message) over a synchronized channel between the network device 510 and the wireless communication devices 520a, 520b. As noted previously, a synchronization message can include one or more commands. For instance, a command can include an operational code (OpCode) and parameters associated with the command. At time 0 ms, the first group of wireless communication devices 520a (e.g., ESL 1, ESL 2, ESL 3, ESL 4, ESL 5, ESL 6, ESL 7, ESL 8, ESL 9, ESL 10, and ESL 11) can receive 535a the PA containing the synchronization message over the synchronized channel.

In one or more examples, the network device 510 may be configured to transmit PAs at a specified time interval (e.g., a subframe of time), such as is shown in FIG. 5. In one or more examples, the specified time interval (e.g., a subframe) may be shorter or longer than the as is shown in FIG. 5. The wireless communication devices 520a, 520b may respond to a PA by using their specific respective response slot in time.

In one or more examples, the synchronization message transmitted 530a to the first group (e.g., group 1) of wireless communication devices 520a (e.g., ESL 1, ESL 2, ESL 3, ESL 4, ESL 5, ESL 6, ESL 7, ESL 8, ESL 9, ESL 10, and ESL 11) may indicate a respective response slot for one or more of the wireless communication devices 520a (e.g., ESL 1, ESL 2, ESL 3, ESL 4, ESL 5, ESL 6, ESL 7, ESL 8, ESL 9, ESL 10, and/or ESL 11) in the first group to use to transmit 540a a response to the network device 510. If a wireless communication device 520a (e.g., ESL 1, ESL 2, ESL 3, ESL 4, ESL 5, ESL 6, ESL 7, ESL 8, ESL 9, ESL 10, and ESL 11) is addressed within the synchronization message, the wireless communication device 520a (e.g., ESL 1, ESL 2, ESL 3, ESL 4, ESL 5, ESL 6, ESL 7, ESL 8, ESL 9, ESL 10, and ESL 11) can respond (e.g., transmit 540a) in its respective response slot, as indicated within the synchronization message. For example, the synchronization message may indicate a specific sequence for one or more of the wireless communication devices 520a (e.g., ESL 1, ESL 2, ESL 3, ESL 4, ESL 5, ESL 6, ESL 7, ESL 8, ESL 9, ESL 10, and/or ESL 11) to respond (e.g., transmit 540a) in time (e.g., responding after 5 ms has elapsed after the start of the subframe 550a at response slots as shown in FIG. 5).

After the wireless communication devices 520a (e.g., ESL 1, ESL 2, ESL 3, ESL 4, ESL 5, ESL 6, ESL 7, ESL 8, ESL 9, ESL 10, and ESL 11) have received 535a the PA containing the synchronization message from the network device 510, according to the sequence specified within the synchronization message, the one or more wireless communication devices 520a (e.g., ESL 1, ESL 2, ESL 3, ESL 4, ESL 5, ESL 6, ESL 7, ESL 8, ESL 9, ESL 10, and/or ESL 11) can transmit 540a their responses within their respective response slots. After the one or more wireless communication devices 520a (e.g., ESL 1, ESL 2, ESL 3, ESL 4, ESL 5, ESL 6, ESL 7, ESL 8, ESL 9, ESL 10, and/or ESL 11) have transmitted 540a their responses in their respective response time slots, the network device 510 can receive 545a their transmitted responses at those specific response slot times.

During operation for PAwR, for the second subframe 550b of time, the network device 510 may transmit 530b to a second group (e.g., group 2) of wireless communication devices 520b (e.g., ESL 12, ESL 13, ESL 14, ESL 15, ESL 16, ESL 17, ESL 18, ESL 19, ESL 20, ESL 21, and ESL 22) a PA containing a synchronization message over a synchronized channel between the network device 510 and the wireless communication devices 520a, 520b. In addition, at the start of the second subframe 550b, the second group of wireless communication devices 520b (e.g., ESL 12, ESL 13, ESL 14, ESL 15, ESL 16, ESL 17, ESL 18, ESL 19, ESL 20, ESL 21, and ESL 22) can receive 535b the PA containing the synchronization message over the synchronized channel.

The synchronization message transmitted 530b to the second group (e.g., group 2) of wireless communication devices 520b (e.g., ESL 12, ESL 13, ESL 14, ESL 15, ESL 16, ESL 17, ESL 18, ESL 19, ESL 20, ESL 21, and ESL 22) may indicate a respective response slot for one or more of the wireless communication devices 520b (e.g., ESL 12, ESL 13, ESL 14, ESL 15, ESL 16, ESL 17, ESL 18, ESL 19, ESL 20, ESL 21, and/or ESL 22) in the second group to use to transmit 540b a response to the network device 510. If a wireless communication device 520b (e.g., ESL 12, ESL 13, ESL 14, ESL 15, ESL 16, ESL 17, ESL 18, ESL 19, ESL 20, ESL 21, and ESL 22) is addressed within the synchronization message, the wireless communication device 520b (e.g., ESL 12, ESL 13, ESL 14, ESL 15, ESL 16, ESL 17, ESL 18, ESL 19, ESL 20, ESL 21, and ESL 22) can respond (e.g., transmit 540b) in its respective response slot, as indicated within the synchronization message. For example, the synchronization message may indicate a specific sequence for one or more of the wireless communication devices 520b (e.g., ESL 12, ESL 13, ESL 14, ESL 15, ESL 16, ESL 17, ESL 18, ESL 19, ESL 20, ESL 21, and/or ESL 22) to respond (e.g., transmit 540b) in time (e.g., responding after 5 ms has elapsed after the start of the subframe at response slots as shown in FIG. 5).

After the wireless communication devices 520b (e.g., ESL 12, ESL 13, ESL 14, ESL 15, ESL 16, ESL 17, ESL 18, ESL 19, ESL 20, ESL 21, and ESL 22) have received 535b the PA containing the synchronization message from the network device 510, according to the sequence specified within the synchronization message, the one or more wireless communication devices 520b (e.g., ESL 12, ESL 13, ESL 14, ESL 15, ESL 16, ESL 17, ESL 18, ESL 19, ESL 20, ESL 21, and/or ESL 22) may transmit 540b their responses within their respective response slots. After the one or more wireless communication devices 520b (e.g., ESL 12, ESL 13, ESL 14, ESL 15, ESL 16, ESL 17, ESL 18, ESL 19, ESL 20, ESL 21, and/or ESL 22) have transmitted 540b their responses in their respective response time slots, the network device 510 can receive 545b their transmitted responses at those specific response slot times. The PAwR may continue similarly for subsequent subframes of time.

As previously mentioned, certain environments (e.g., retail environments, warehouses, etc.) may employ ambient IoT devices (e.g., tags) and energizing devices for indoor navigation, asset tracking using the ambient IoT devices, and inventory management. Given a large number of ambient IoT devices (e.g., tags) located within an indoor environment (e.g., a store or warehouse), there may be a large amount of interference on the uplink channel (e.g., towards the ESLs and access points). This interference problem may be exacerbated by the fact that ambient IoT devices (e.g., tags) typically do not have a complete receiver module and, thus, are not able to receive scheduling information or payload information on the downlink channel. Therefore, improved systems and techniques for scheduling of ambient IoT devices (e.g., in smart retail, warehouses, etc.) such that there is a reduction in interference on the uplink channel can be useful.

In one or more aspects, as noted previously, the systems and techniques provide solutions for uplink scheduling of computing devices, such as ambient IoT devices (e.g., transmit-only ambient IoT tags). For instance, the systems and techniques can provide solutions for scheduling ambient IoT devices (e.g., tags) for a reduction in interference on an uplink channel. In one or more aspects, for a reduction of interference on the uplink channel, the systems and techniques provide solutions that involve pre-configured ambient IoT devices (e.g., tags) whose transmission behavior (e.g., frequency channel and/or time for transmission) is hard-wired prior to their deployment, criteria for forming a group of ambient IoT devices (e.g., tags) for interference mitigation, and on-the-fly reconfiguration of frequency behavior of ambient IoT devices (e.g., tags) by using a waveform pattern of an energizer transmission or using a configuration of a switch. In one or more examples, transmissions of ambient IoT devices may be multiplexed in the time domain or the frequency domain. In some examples, an ambient IoT device of a group of ambient IoT devices can be pre-configured (e.g., preprogrammed or hardwired during the manufacturing phase) to regulate its transmissions. In some examples, ambient IoT devices may be grouped together within a group based on their area of deployment, product type, batch identification, mode of transportation, priority, and/or susceptibility to interference based on the store layout. In one or more examples, an ambient IoT device can be reconfigured (e.g., programmed) on-the-fly using a pre-known waveform pattern of an energizing transmission to operate in a certain mode of operation. A lookup table including different waveform patterns for the energizing transmissions corresponding to the different modes of operation may be stored (e.g., programmed) within the ambient IoT device prior to deployment. In some examples, a series of ambient IoT devices can be sequentially programmed (e.g., reconfigured), such as being moved along on a conveyor belt, by energizing transmissions transmitted from an energizing device to operate in non-interfering modes of operation, based on different criteria. In one or more examples, the different modes of operation for an ambient IoT device may be selected by toggling a physical mechanical switch incorporated within the ambient IoT device itself.

In one or more examples, during operation for wireless communications, a computing device (e.g., an ambient IoT device) may receive an energizer transmission from an energizing device. The computing device may store energy from the energizer transmission. The computing device may transmit, based on the stored energy, a response signal using a particular frequency channel and/or a particular time. In one or more examples, the computing device can be configured to transmit using the particular frequency channel and/or the particular time, based on a type of the computing device, the energizer transmission, or a configuration of a switch associated with the computing device. In one or more examples, based on the type of the computing device, the computing device may be pre-configured to transmit with a certain duty cycle, every n^{th} number time slot of a time grid, and/or a certain time offset within a time slot of the time grid. In some examples, the computing device can have a physical characteristic indicating the type of the computing device. In one or more examples, the computing device can be pre-configured to transmit the response signal with an orthogonal preamble sequence.

In one or more examples, the computing device may be within a group of computing devices. In some examples, computing devices within the group of computing devices are included within the group based on one or more grouping factors. For instance, the computing devices can be included in the group based on the computing devices being within a same area of deployment, being of a same product type, having a same batch identification, being transported together, having a same priority, being susceptible to interference based on a store layout, etc. In some examples, the area of deployment can be on a certain shelf or within a certain aisle. In one or more examples, when the computing devices within the group of computing devices have a higher priority than other computing devices within other groups, the computing devices within the group of computing devices may be pre-configured to transmit more frequently than the other computing devices within the other groups. In some examples, the computing device can be reconfigured to transmit using the particular frequency channel and/or the particular time based on a waveform pattern of the energizer transmission. In some examples, the waveform pattern can be a burst pattern (e.g., an ON/OFF pattern). In one or more examples, the computing device may be pre-configured to have stored a plurality of different waveform patterns including the waveform pattern. In one or more examples, the computing device can be reconfigured to transmit using the particular frequency channel and/or the particular time based on the configuration of the switch associated with the computing device.

In one or more aspects, the systems and techniques mitigate the inter-ambient IoT device (e.g., tag) interference over the uplink channel by multiplexing the ambient IoT device transmissions in the time domain or the frequency domain. In one or more examples, the transmission behavior (e.g., frequency channel and/or time for transmission) can be pre-configured (e.g., preprogrammed or hardwired) for an ambient IoT device prior to its deployment (e.g., during the manufacturing phase of the ambient IoT device). For example, an ambient IoT device may be pre-configured to be a certain type of device (e.g., a type A tag, a type B tag, a type C tag, a type D tag, a type E tag, or a type F tag). Ambient IoT devices of a certain type are pre-configured to always transmit transmissions (e.g., response signals) on a certain frequency channel (e.g., at a specific frequency band) and/or at a certain time (e.g., to transmit at a time that is after a duration of a specific timing offset after the end of an energizer transmission). For example, ambient IoT devices of a type A tag may be pre-configured to always transmit transmissions on a first frequency channel, and ambient IoT devices of a type B tag may be pre-configured to always transmit transmissions on a second frequency channel. In one or more examples, an ambient IoT device can have a physical characteristic (e.g., color and/or textual label) that indicates the type of device (e.g., type A tag) associated with the ambient IoT device.

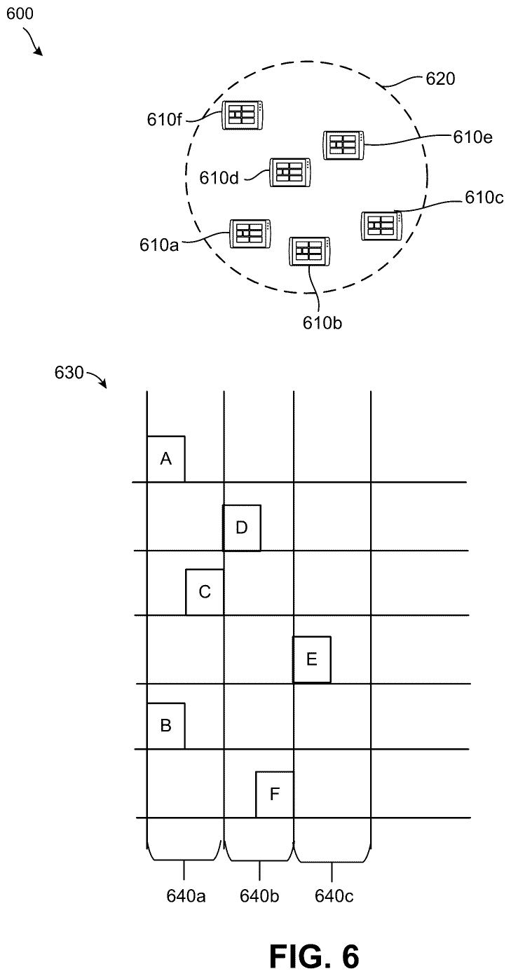

In one or more examples, time-domain multiplexing may be employed to prevent interference amongst ambient IoT devices (e.g., tags). For example, ambient IoT devices of a certain type (e.g., type A tag) may be pre-configured to always transmit transmissions (e.g., response signals) with a certain duty cycle (e.g., a frequency of transmissions over time), every predetermined number (e.g., every n^{th} number) of time slots (e.g., subframe, such as subframes 550a, 550b of FIG. 5 and subframes 640a, 640b, 640c of FIG. 6) of a time grid (e.g., with respect to a start of an ESL transmission schedule), or a certain time offset within a time slot of the time grid. In some examples, an ambient IoT device can be pre-configured to transmit transmissions (e.g., response signals) with an orthogonal preamble sequence (e.g., which can be descrambled at a receiver, for example an ESL, access point, or an edge server).

In one or more examples, a group of co-located ambient IoT devices (e.g., tags) (e.g., which may be deployed together within a certain area of a threshold radius of distance) can be pre-configured with different configurations (e.g., configured as different types of devices) such that their transmissions (e.g., response signals) do not interfere with each other. FIG. 6 is a diagram illustrating an example 600 of ambient IoT devices 610a, 610b, 610c, 610d, 610c, 610f configured with different configurations. In FIG. 6, a plurality of IoT devices (e.g., tags) 610a, 610b, 610c, 610d, 610e, 610f are shown to be co-located together within an area 620. In order to mitigate interference of their transmissions (e.g., response signals), each of the ambient IoT devices 610a, 610b, 610c, 610d, 610e, 610f is pre-configured (e.g., prior to deployment) to be a different type of device (e.g., tag). For example, ambient IoT device 610a is pre-configured to be a type A tag, ambient IoT device 610b is pre-configured to be a type B tag, ambient IoT device 610c is pre-configured to be a type C tag, ambient IoT device 610d is pre-configured to be a type D tag, ambient IoT device 610e is pre-configured to be a type E tag, and ambient IoT device 610f is pre-configured to be a type F tag.

Each type of device (e.g., tag) is pre-configured to always transmit transmissions (e.g., response signals) on a certain frequency channel (e.g., at a specific frequency band) and/or at a certain time. FIG. 6 includes a graph 630 that shows examples of the different frequency channels and the different times that the different type of devices (e.g., tags) are pre-configured for transmissions. For the graph 630 (e.g., a time grid), the x-axis denotes time (e.g., in milliseconds) and the y-axis denotes frequency. In particular, the time of the graph 630 can be divided into three subframes 640a, 640b, 640c (e.g., time slots). As such, the three subframes 640a, 640b, 640c may include a first subframe 640a, a second subframe 640b, and a third subframe 640c. In one or more examples, there may be more or less than three subframes 640a, 640b, 640c as is shown in FIG. 6, and/or each subframe 640a, 640b, 640c may be longer or shorter than as shown in FIG. 6.

In FIG. 6, the graph 630 shows that the ambient IoT device 610a of a type A tag is pre-configured to transmit transmissions (e.g., response signals) at a sixth frequency channel at a time of the start of the first subframe 640a (e.g., first time slot), and the ambient IoT device 610b of a type B tag is pre-configured to transmit transmissions at a second frequency channel at the time of the start of the first subframe 640a. As such, the ambient IoT device 610a and the ambient device 610b are pre-configured to have transmissions that overlap in the time domain, but not in the frequency domain. Transmissions may overlap in the time domain (as shown in the graph 630), but to avoid interference, the transmissions need to use different frequency channels (as shown in the graph 630) or use different orthogonal preamble sequences.

In one or more aspects, computing devices, such as ambient IoT devices (e.g., tags) can be included in a group of computing devices based on one or more grouping factors. Grouping factors can include the computing devices being a same area of deployment, being of a same product type, having a same batch identification, being transported together, having a same priority, being susceptible to interference based on a store layout, any combination thereof, and/or other grouping factors. For instance, in some aspects, a criteria for forming a group of ambient IoT devices (e.g., tags) to reduce interference is related to the ambient IoT devices being co-located within an area of a threshold radius of distance. In one or more examples, a group of ambient IoT devices may be formed based on the ambient IoT devices being located within the same coarse area of deployment. In some examples, the area of deployment may be on a certain shelf (e.g., with a certain shelf identification number) or in a certain aisle (e.g., with a certain aisle number). In one or more examples, a group of ambient IoT devices may be formed based on the ambient IoT devices being associated with the same product type. For example, the same types of products (e.g., with their associated ambient IoT devices) may be grouped because they are likely going to be transported and installed within the same area together. In some examples, a group of ambient IoT devices may be formed based on the ambient IoT devices having the same batch identification. For example, products (e.g., with their associated ambient IoT devices) with the same batch identification may be grouped because they are to be transported together (e.g., within the same box, container, pallet, and/or forklift).

In one or more examples, a group of ambient IoT devices may be formed based on a priority of the products associated with the ambient IoT devices. For example, certain products (e.g., with their associated ambient IoT devices) with the same priority (e.g., a high priority or a low priority) can be grouped together. In some examples, products with a high priority may be assigned a specific type of device (e.g., a specific type of tag) that transmits more often (e.g., more frequently, with a shorter duty cycle) than other types of devices (e.g., other types of tags). In one or more examples, products with a low priority may be assigned a specific type of device (e.g., a specific type of tag) that transmits less frequently (e.g., with a longer duty cycle) than other types of devices (e.g., other types of tags).

In one or more examples, a group of ambient IoT devices may be formed based on the susceptibility of the ambient IoT devices to interference based on the store layout (or warehouse layout). For example, with prior knowledge of the layout of the store (or warehouse), groups of ambient IoT devices that are more sensitive to interference may be identified. For instance, in a relatively open area of the store (e.g., the produce section), the ambient IoT devices located within this area can be more susceptible to interference with each other. Conversely, in a closed area of the store (e.g., an area shielded by tall gondolas, shelving units, and/or walls), the ambient IoT devices located within this area can be less susceptible to interference with each other.

In one or more aspects, ambient IoT devices (e.g., tags) may be reconfigured on-the-fly after their deployment. In one or more examples, ambient IoT devices can be reconfigured to transmit using a particular frequency channel and/or at a particular time based on a waveform pattern of the energizer transmission. In some examples, the waveform pattern may be a burst pattern (e.g., an ON/OFF pattern). The pattern can indicate to the ambient IoT device to operate in a certain mode (e.g., transmit using a certain frequency channel, with a certain duty cycle, and/or with a certain time offset). Different waveform patterns can correspond to different modes of operation. A lookup table including the different waveform patterns with their corresponding modes can be stored (e.g., programmed) within an ambient IoT device prior to its deployment.

In one or more examples, an automated process may be employed that on-the-fly reconfigures ambient IoT devices to operate in specific modes. For example, a series of ambient IoT devices may be guided along a conveyor belt or supply chain machinery, while a stationary energizing device transmits energizer transmissions sequentially to each of the ambient IoT devices as they travel by the energizing device. The energizing device can reconfigure each of the ambient IoT devices to operate in a non-interfering mode such that the ambient IoT device transmits on a different frequency channel and/or at a different time than the other ambient IoT devices.

In one or more examples, the automated process and/or the energizer transmission configuration may be controlled by a software entity. In one or more examples, the software entity may control the automated process and/or the energizer transmission configuration based on: a coarse area of deployment of the ambient IoT devices; a product type associated with the ambient IoT devices; a batch identification associated with the ambient IoT devices; a priority of the products associated with the ambient IoT devices; a susceptibility to interference of the ambient IoT devices based on the store layout; a number, type, and requirement of products that need to be assigned with the ambient IoT devices; and/or whether programmability is required (e.g., when a product is expected to travel through various locations, programmability can be beneficial).

In one or more examples, an ambient IoT device can be reconfigured to transmit using a particular frequency channel and/or at a particular time based on a configuration of a switch associated with the ambient IoT device. In one or more examples, an ambient IoT device may have a physical mechanical switch incorporated within itself. The toggling (e.g., by a user) of the mechanical switch to different switching configurations can cause the ambient IoT device to operate in different modes of operation.

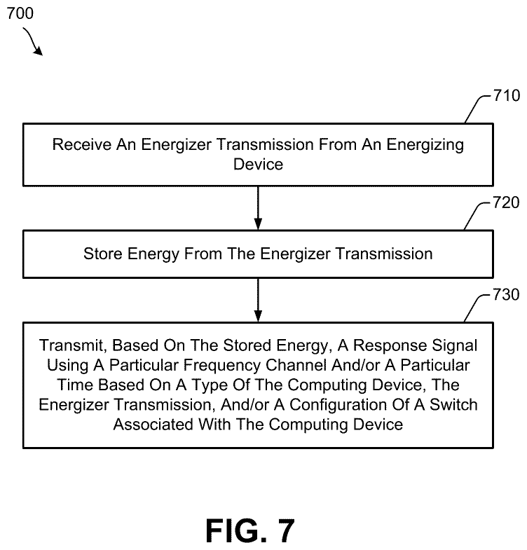

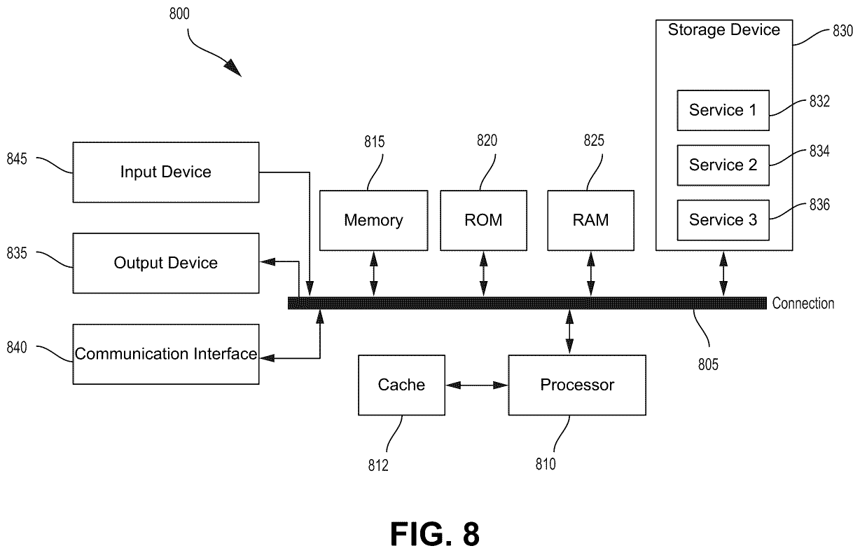

FIG. 7 is a flow chart illustrating an example of a process 700 for uplink scheduling of computing devices, such as ambient IoT devices (e.g., transmit-only ambient IoT tags). The process 700 can be performed by a computing device (e.g., ambient IoT device 310 of FIG. 3, ambient IoT devices 610a-610f of FIG. 6, or a computing device or computing system 800 of FIG. 8) or by a component or system (e.g., a chipset, one or more processors such as one or more central processing units (CPUs), digital signal processors (DSPs), graphics processing units (GPUs), any combination thereof, and/or other type of processor(s), or other component or system) of the computing device. In some cases, the computing device can include the computing system 800 of FIG. 8. The operations of the process 700 may be implemented as software components that are executed and run on one or more processors (e.g., processor 810 of FIG. 8 or other processor(s)). Further, the transmission and reception of signals by the computing device in the process 700 may be enabled, for example, by one or more antennas and/or one or more transceivers (e.g., wireless transceiver(s)).

At block 710, the computing device (or component thereof, such as at least one transceiver, processor, or other component) can receive an energizer transmission from an energizing device. At block 720, the computing device (or component thereof) can store energy from the energizer transmission (e.g., in at least one memory of the computing device).

At block 730, the computing device (or component thereof, such as at least one transceiver) can transmit (or output for transmission), based on the stored energy, a response signal using a particular frequency channel, a particular time, or a combination thereof based on a type of the computing device, the energizer transmission, a configuration of a switch associated with the computing device, or a combination thereof. In some aspects, the computing device is pre-configured, based on the type of the computing device, to transmit with a certain duty cycle, every predetermined number of time slots of a time grid (e.g., every n^{th} number of time slots of a time grid, such as at subframes 550a, 550b of FIG. 5, subframes 640a, 640b, 640c of FIG. 6, etc.), with a certain time offset within a time slot of the time grid, or any combination thereof. In some cases, the computing device is pre-configured to transmit the response signal with an orthogonal preamble sequence. In some aspects, the computing device is reconfigured to transmit using the particular frequency channel and/or the particular time based on the configuration of the switch associated with the computing device.

In some cases, the computing device has a physical characteristic indicating the type of the computing device. For instance, the computing device may have a particular color, label (e.g., textual label, icon, logo, etc.), and/or other physical characteristic that indicates the type of device (e.g., a type A ambient IoT tag) associated with the computing device.

In some aspects, the computing device is within a group of computing devices. In some cases, computing devices are included within the group of computing devices based on one or more grouping factors. For instance, the one or more grouping factors can include the computing devices being within a same area of deployment, being of a same product type, having a same batch identification, being transported together, having a same priority, being susceptible to interference based on a layout of an environment in which the computing devices are located, any combination thereof, and/or other grouping factors. In some cases, based on the computing devices within the group of computing devices having a higher priority than other computing devices within one or more other groups of computing devices, the computing devices within the group of computing devices are pre-configured to transmit more frequently than the other computing devices within the one or more other groups. In some examples, the computing device is reconfigured to transmit using the particular frequency channel and/or the particular time based on the one or more grouping factors for including the computing devices within the group of computing devices.

In some aspects, the computing device is reconfigured to transmit using the particular frequency channel and/or the particular time based on a waveform pattern of the energizer transmission. For instance, the waveform pattern may include an ON/OFF burst pattern. In some cases, the computing device is pre-configured to store a plurality of different waveform patterns including the waveform pattern.

In some cases, the computing device of process 700 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 700 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 700 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 700 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

FIG. 8 is a block diagram illustrating an example of a computing system 800, which may be employed for uplink scheduling of computing devices, such as ambient IoT devices (e.g., transmit-only ambient IoT tags). In particular, FIG. 8 illustrates an example of computing system 800, which can be for example any computing device making up internal computing system, a remote computing system, a camera, or any component thereof in which the components of the system are in communication with each other using connection 805. Connection 805 can be a physical connection using a bus, or a direct connection into processor 810, such as in a chipset architecture. Connection 805 can also be a virtual connection, networked connection, or logical connection.

In some aspects, computing system 800 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 800 includes at least one processing unit (CPU or processor) 810 and connection 805 that communicatively couples various system components including system memory 815, such as read-only memory (ROM) 820 and random access memory (RAM) 825 to processor 810. Computing system 800 can include a cache 812 of high-speed memory connected directly with, in close proximity to, or integrated as part of processor 810.

Processor 810 can include any general purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms. In some instances, multimodal systems can enable a user to provide multiple types of input/output to communicate with computing system 800.

Computing system 800 can include communications interface 840, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 840 may also include one or more range sensors (e.g., LIDAR sensors, laser range finders, RF radars, ultrasonic sensors, and infrared (IR) sensors) configured to collect data and provide measurements to processor 810, whereby processor 810 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), crasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 830 can include software services, servers, services, etc., that when the code that defines such software is executed by the processor 810, it causes the system to perform a function. In some aspects, a hardware service that performs a particular function can include the software component stored in a computer-readable medium in connection with the necessary hardware components, such as processor 810, connection 805, output device 835, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) cither directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. A computing device for wireless communication, the computing device comprising: at least one memory; and at least one processor coupled to the at least one memory and configured to: receive an energizer transmission from an energizing device; store energy from the energizer transmission in the at least one memory; and output, based on the stored energy, a response signal for transmission using at least one of a particular frequency channel or a particular time based on at least one of a type of the computing device, the energizer transmission, or a configuration of a switch associated with the computing device.

Aspect 2. The computing device of Aspect 1, wherein the computing device is pre-configured, based on the type of the computing device, to transmit with at least one of a certain duty cycle, every predetermined number of time slots of a time grid, or with a certain time offset within a time slot of the time grid.

Aspect 3. The computing device of any one of Aspects 1 or 2, wherein the computing device has a physical characteristic indicating the type of the computing device.

Aspect 4. The computing device of any one of Aspects 1 to 3, wherein the computing device is pre-configured to transmit the response signal with an orthogonal preamble sequence.

Aspect 5. The computing device of any one of Aspects 1 to 4, wherein the computing device is within a group of computing devices.

Aspect 6. The computing device of Aspect 5, wherein computing devices are included within the group of computing devices based on one or more grouping factors, the one or more grouping factors comprising at least one of the computing devices being within a same area of deployment, being of a same product type, having a same batch identification, being transported together, having a same priority, or being susceptible to interference based on a layout of an environment in which the computing devices are located.

Aspect 7. The computing device of Aspect 6, wherein, based on the computing devices within the group of computing devices having a higher priority than other computing devices within one or more other groups of computing devices, the computing devices within the group of computing devices are pre-configured to transmit more frequently than the other computing devices within the one or more other groups.

Aspect 8. The computing device of any one of Aspects 6 or 7, wherein the computing device is reconfigured to transmit using the at least one of the particular frequency channel or the particular time based on the one or more grouping factors for including the computing devices within the group of computing devices.

Aspect 9. The computing device of any one of Aspects 1 to 8, wherein the computing device is reconfigured to transmit using the at least one of the particular frequency channel or the particular time based on the configuration of the switch associated with the computing device.

Aspect 10. The computing device of any one of Aspects 1 to 9, wherein the computing device is reconfigured to transmit using the at least one of the particular frequency channel or the particular time based on a waveform pattern of the energizer transmission.

Aspect 11. The computing device of Aspect 10, wherein the waveform pattern is an ON/OFF burst pattern.

Aspect 12. The computing device of any one of Aspects 10 or 11, wherein the computing device is pre-configured to store a plurality of different waveform patterns comprising the waveform pattern.

Aspect 13. The computing device of any one of Aspects 1 to 12, wherein the computing device is an ambient Internet-of-things (IoT) device.

Aspect 14. The computing device of any one of Aspects 1 to 13, further comprising at least one transceiver configured to receive the energizer transmission from the energizing device and to transmit the response signal using the at least one of the particular frequency channel or the particular time.

Aspect 15. A method for wireless communication, the method comprising: receiving, by a computing device, an energizer transmission from an energizing device; storing, by the computing device, energy from the energizer transmission; and transmitting, by the computing device based on the stored energy, a response signal using at least one of a particular frequency channel or a particular time based on at least one of a type of the computing device, the energizer transmission, or a configuration of a switch associated with the computing device.

Aspect 16. The method of Aspect 15, wherein the computing device is pre-configured, based on the type of the computing device, to transmit with at least one of a certain duty cycle, every predetermined of number time slots of a time grid, or with a certain time offset within a time slot of the time grid.

Aspect 17. The method of any one of Aspects 15 or 16, wherein the computing device has a physical characteristic indicating the type of the computing device.

Aspect 18. The method of any one of Aspects 15 to 17, wherein the computing device is pre-configured to transmit the response signal with an orthogonal preamble sequence.

Aspect 19. The method of any one of Aspects 15 to 18, wherein the computing device is within a group of computing devices.

Aspect 20. The method of Aspect 19, wherein computing devices are included within the group of computing devices based on one or more grouping factors, the one or more grouping factors comprising at least one of the computing devices being within a same area of deployment, being of a same product type, having a same batch identification, being transported together, having a same priority, or being susceptible to interference based on a layout of an environment in which the computing devices are located.

Aspect 21. The method of Aspect 20, wherein, based on the computing devices within the group of computing devices having a higher priority than other computing devices within one or more other groups of computing devices, the computing devices within the group of computing devices are pre-configured to transmit more frequently than the other computing devices within the one or more other groups.

Aspect 22. The method of any one of Aspects 20 or 21, wherein the computing device is reconfigured to transmit using the at least one of the particular frequency channel or the particular time based on the one or more grouping factors for including the computing devices within the group of computing devices.

Aspect 23. The method of any one of Aspects 15 to 22, wherein the computing device is reconfigured to transmit using the at least one of the particular frequency channel or the particular time based on the configuration of the switch associated with the computing device.

Aspect 24. The method of any one of Aspects 15 to 23, wherein the computing device is reconfigured to transmit using the at least one of the particular frequency channel or the particular time based on a waveform pattern of the energizer transmission.

Aspect 25. The method of Aspect 24, wherein the waveform pattern is an ON/OFF burst pattern.

Aspect 26. The method of any one of Aspects 24 or 25, wherein the computing device is pre-configured to store a plurality of different waveform patterns comprising the waveform pattern.

Aspect 27. The method of any one of Aspects 15 to 26, wherein the computing device is an ambient Internet-of-things (IoT) device.

Aspect 28. A non-transitory computer-readable medium having stored thereon instructions that, when executed by one or more processors, cause the one or more processors to perform operations according to any of Aspects 15 or 27.

Aspect 29. An apparatus for wireless communication, the apparatus including one or more means for performing operations according to any of Aspects 15 or 27.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. A computing device for wireless communication, the computing device comprising:
at least one memory; and
at least one processor coupled to the at least one memory and configured to:
receive an energizer transmission from an energizing device;
store energy from the energizer transmission in the at least one memory; and
output, based on the stored energy, a response signal for transmission using at least one of a particular frequency channel or a particular time based on at least one of a type of the computing device, the energizer transmission, or a configuration of a switch associated with the computing device.

2. The computing device of claim 1, wherein the computing device is pre-configured, based on the type of the computing device, to transmit with at least one of a certain duty cycle, every predetermined number of time slots of a time grid, or with a certain time offset within a time slot of the time grid.

3. The computing device of claim 1, wherein the computing device has a physical characteristic indicating the type of the computing device.

4. The computing device of claim 1, wherein the computing device is pre-configured to transmit the response signal with an orthogonal preamble sequence.

5. The computing device of claim 1, wherein the computing device is within a group of computing devices.

6. The computing device of claim 5, wherein computing devices are included within the group of computing devices based on one or more grouping factors, the one or more grouping factors comprising at least one of the computing devices being within a same area of deployment, being of a same product type, having a same batch identification, being transported together, having a same priority, or being susceptible to interference based on a layout of an environment in which the computing devices are located.

7. The computing device of claim 6, wherein, based on the computing devices within the group of computing devices having a higher priority than other computing devices within one or more other groups of computing devices, the computing devices within the group of computing devices are pre-configured to transmit more frequently than the other computing devices within the one or more other groups.

8. The computing device of claim 6, wherein the computing device is reconfigured to transmit using the at least one of the particular frequency channel or the particular time based on the one or more grouping factors for including the computing devices within the group of computing devices.

9. The computing device of claim 1, wherein the computing device is reconfigured to transmit using the at least one of the particular frequency channel or the particular time based on the configuration of the switch associated with the computing device.

10. The computing device of claim 1, wherein the computing device is reconfigured to transmit using the at least one of the particular frequency channel or the particular time based on a waveform pattern of the energizer transmission.

11. The computing device of claim 10, wherein the waveform pattern is an ON/OFF burst pattern.

12. The computing device of claim 10, wherein the computing device is pre-configured to store a plurality of different waveform patterns comprising the waveform pattern.

13. The computing device of claim 1, wherein the computing device is an ambient Internet-of-things (IoT) device.

14. The computing device of claim 1, further comprising at least one transceiver configured to receive the energizer transmission from the energizing device and to transmit the response signal using the at least one of the particular frequency channel or the particular time.

15. A method for wireless communication, the method comprising:
receiving, by a computing device, an energizer transmission from an energizing device;
storing, by the computing device, energy from the energizer transmission; and
transmitting, by the computing device based on the stored energy, a response signal using at least one of a particular frequency channel or a particular time based on at least one of a type of the computing device, the energizer transmission, or a configuration of a switch associated with the computing device.

16. The method of claim 15, wherein the computing device is pre-configured, based on the type of the computing device, to transmit with at least one of a certain duty cycle, every predetermined number of time slots of a time grid, or with a certain time offset within a time slot of the time grid.

17. The method of claim 15, wherein the computing device has a physical characteristic indicating the type of the computing device.

18. The method of claim 15, wherein the computing device is pre-configured to transmit the response signal with an orthogonal preamble sequence.

19. The method of claim 15, wherein the computing device is within a group of computing devices, and wherein computing devices are included within the group of computing devices based on one or more grouping factors, the one or more grouping factors comprising at least one of the computing devices being within a same area of deployment, being of a same product type, having a same batch identification, being transported together, having a same priority, or being susceptible to interference based on a layout of an environment in which the computing devices are located.

20. The method of claim 15, wherein the computing device is reconfigured to transmit using the at least one of the particular frequency channel or the particular time based on at least one of one or more grouping factors for including the computing device within a group of computing devices, based on the configuration of the switch associated with the computing device, or based on a waveform pattern of the energizer transmission.
